(19) United States
(12) Patent Application Publication
(10) Pub. No.: US 2008/0105213 A1
(43) Pub. Date: May 8, 2008

(54) Air-Conditioning Device For Pet and Pet House Having The Same

(76) Inventor: Shih H. Chen, Yongkang City (TW)

Correspondence Address: HDSL, 4331 STEVENS BATTLE LANE, FAIRFAX, VA, 22033, US

(21) Appl. No.: 11/556,279

(22) Filed: Nov. 3, 2006

(51) Int. Cl. A01K 1/03; F24F 7/06

(52) U.S. Cl. 119/500; 454/232; 454/233

(57) ABSTRACT

An air-conditioning device generating cool/warm airflow and suitable for a pet house includes a casing having an outlet and an inlet. A cool/warm air conditioner is provided transversely in the casing to divide the casing into two flowing paths. The cool/warm air conditioner provides the two flowing paths with a cool temperature and a warm temperature, respectively. An airflow-dividing valve comprises a dividing plate provided at the outlet of the casing and a connecting pipe provided on the dividing plate. Each gas-supplying hole is provided on the dividing plate to correspond to the two flowing paths, respectively. Each wind unit is provided within the two flowing paths. With the airflow generated by the two wind units, the cool and warm temperature air generated by the cool/warm air conditioner can be transferred in a form of airflow to the gas-supplying holes. The user can choose the cool air or the warm air via the connecting pipe to adjust the temperature within the pet house.

### BACKGROUND OF THE INVENTION

1. Field of the Invention

The present invention relates to an air-conditioning device, and in particular to an air-conditioning device for exclusive use in a pet house.

2. Description of Prior Art

With the advancement of the civil society of human beings, raising a pet has already become a kind of recreation in their leisure time. Further, with the promotion of the level of life, people not only pay attention to their quality of life, but also care about the living environment of pets. Especially, in the environments having large variation in climate or large temperature difference between daytime and nighttime, not only people need an air-conditioning device to adjust the temperature of their residential environment, but also they should carefully take care of their pets. Therefore, the raiser should always pay attention to the environmental temperature within the pet house, thereby to prevent the pets from catching a cold or get a heatstroke.

With regard to the technique of improving the environmental temperature for pets, for example, it is disclosed in Taiwan Patent Publication No. M285902 entitled “Pet case having an air-conditioning device”. However, such a conventional air-conditioning device for a pet house only provides cool air. The way of generating the cool air is achieved by a compressor. Such a pet house is usually disposed outdoors, so that the noise generated by the compressor will not affect the people in their house. However, such noise still hurts the pets. Further, it cannot provide warm air. Thus, such air-conditioning device can only be used in summer but not in winter.

In addition, Taiwan Patent Publication No. M289965 entitled “Pet house for lowering temperature to provide a suited raising environment” utilizes a thermoelectric cooling chip to adjust the temperature. However, such a device only provides cool air. There is still no thermoelectric cooling chip that is able to generate cool air and warm air.

In view of the above, the inventor proposes the present invention to overcome the above problems based on his expert experiences and deliberate researches.

### SUMMARY OF THE INVENTION

The present invention is to provide an air-conditioning device for pets and a pet house having the air-conditioning device. The air-conditioning device can be used to generate cool and warm air. With the switching operation of a valve, the user can decide to provide the cool air or warm air for the pet house

The present invention is to provide an air-conditioning device for pets, which comprises a casing with an accommodating space therein. The accommodating space is open and has an inlet and an outlet. A cool/warm air conditioner is provided transversely in the accommodating space, so that the accommodating space is divided into a first flowing path and a second flowing path. The cool/warm air conditioner provides the first flowing path and the second flowing path with a cool temperature and a warm temperature, respectively. An airflow-dividing valve comprises a dividing plate provided at the outlet of the accommodating space and a connecting pipe provided on the dividing plate. The dividing plate is provided with a first gas-supplying hole and a second gas-supplying hole to correspond to the first flowing path and the second flowing path, respectively. A first wind unit and a second wind unit are provided within the first flowing path and the second flowing path, respectively. With the first and second wind units, the cool temperature and warm temperature air generated by the cool/warm air conditioner can be transferred in a form of airflow to the first and second gas-supplying holes, respectively. The user can choose the cool air or the warm air via the connecting pipe to adjust the temperature within the pet house.

The present invention is to provide a pet house having an air-conditioning device. The air-conditioning device of the aforementioned type is connected to an intake of the pet house via an airflow conduit and then connected to the connecting pipe. Another airflow conduit is connected to an exhausting port of the pet house and then connected to the inlet of the accommodating space. With the above arrangement, the circulation of airflow can be used to increase the heat-exchange efficiency of the cool/warm air conditioner.

### BRIEF DESCRIPTION OF THE DRAWINGS

FIG. 1 is an exploded perspective view of the first embodiment of the air-conditioning device of the present invention;

FIG. 2 is an assembled perspective view of the first embodiment of the air-conditioning device of the present invention;

FIG. 3 is a cross-sectional view of the first embodiment of the air-conditioning device of the present invention;

FIG. 4 is a schematic view (I) showing the operation of the airflow-dividing valve of the first embodiment of the air-conditioning device of the present invention;

FIG. 5 is a schematic view (II) showing the operation of the airflow-dividing valve of the first embodiment of the air-conditioning device of the present invention;

FIG. 6 is a schematic view showing the operating state of the air-conditioning device of the present invention and the pet house;

FIG. 7 is a schematic view showing another operating state of the air-conditioning device of the present invention and the pet house;

FIG. 8 is a cross-sectional view of the second embodiment of the air-conditioning device of the present invention; and

FIG. 9 is an assembled perspective view of the third embodiment of the air-conditioning device of the present invention.

### DETAILED DESCRIPTION OF THE INVENTION

In order to make the Examiner to better understand the characteristics and the technical contents of the present invention, a description relating thereto will be made with reference to the accompanying drawings. However, it should be understood that the drawings are illustrative but not used to limit the scope of the present invention.

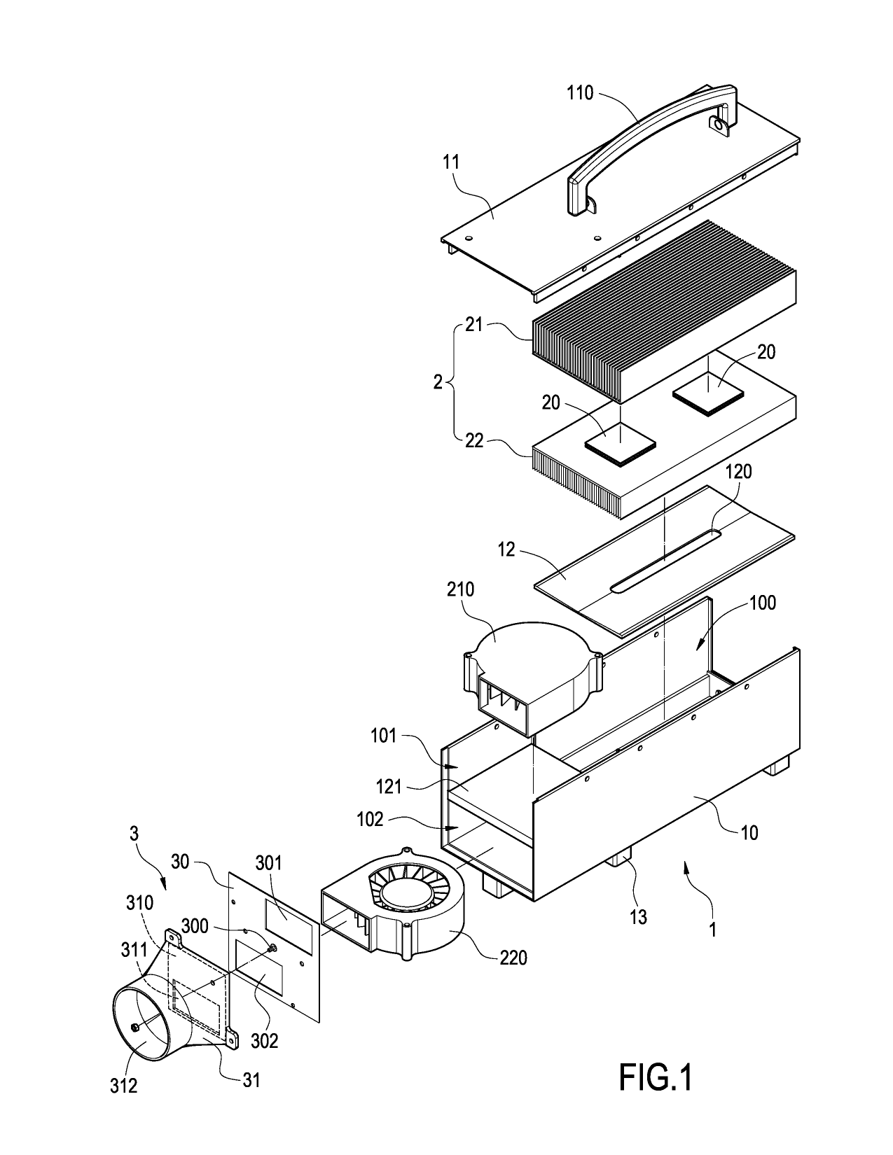

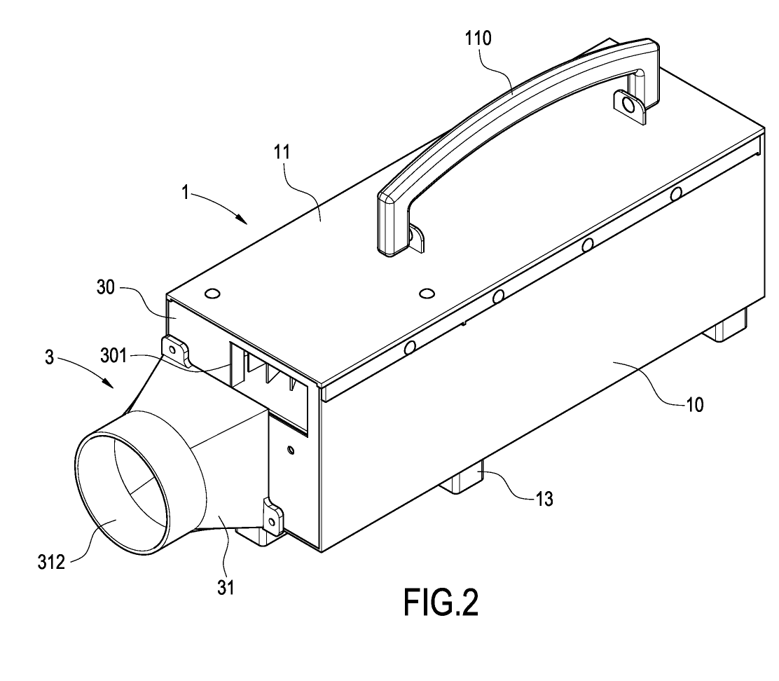

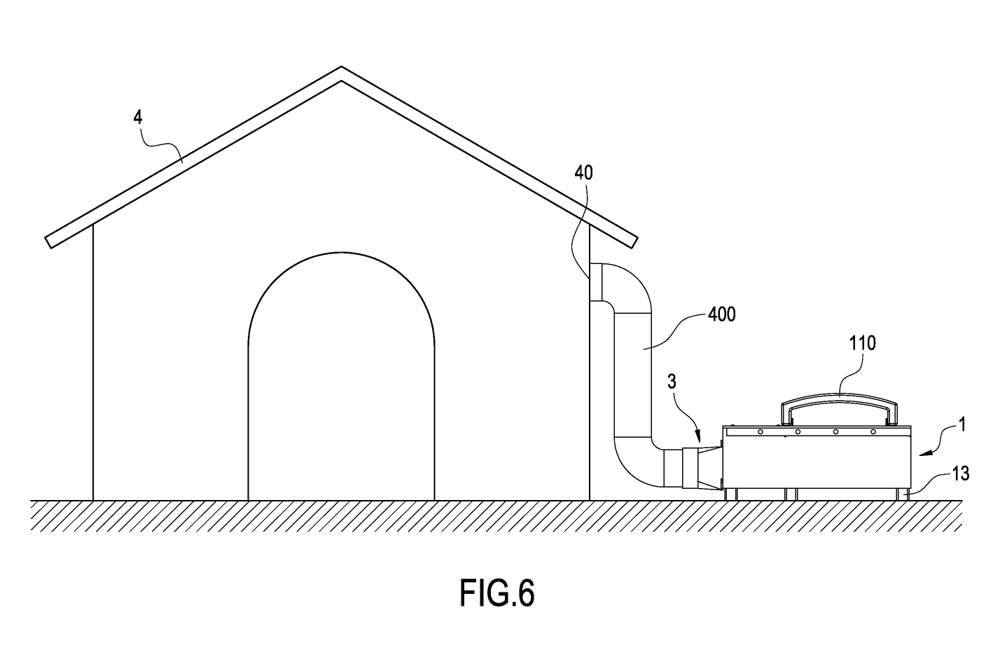

FIGS. 1, 2 and 3 are an exploded perspective view, an assembled perspective view and a cross-sectional view of the first embodiment of the air-conditioning device of the present invention, respectively. The present invention provides an air-conditioning device for pets. The device is used for air-conditioning the temperature within a pet house 4 (FIG. 6), providing the pet house with cool air or warm air, and adjusting to a suitable temperature, thereby to provide the pets with a comfortable environmental temperature. The device includes a casing 1, a cool/warm air conditioner 2 and an airflow-dividing valve 3.

The casing 1 is an elongated hollow body and constituted of a base 10 having a U-shaped cross section and an upper cover 11 disposed on the top of the base 10. The interior of the base 10 has an accommodating space 100 for receiving the cool/warm air conditioner 2. Further, both ends of the base 10 are open and in communication with the accommodating space 100, and thus they serves as an inlet and an outlet of the accommodating space 100, respectively. In addition, a plurality of supporting legs 13 is provided under the base 10 for supporting the casing 1. A handle 110 is provided on the upper cover 11, so that it is easily to carry the air-conditioning device.

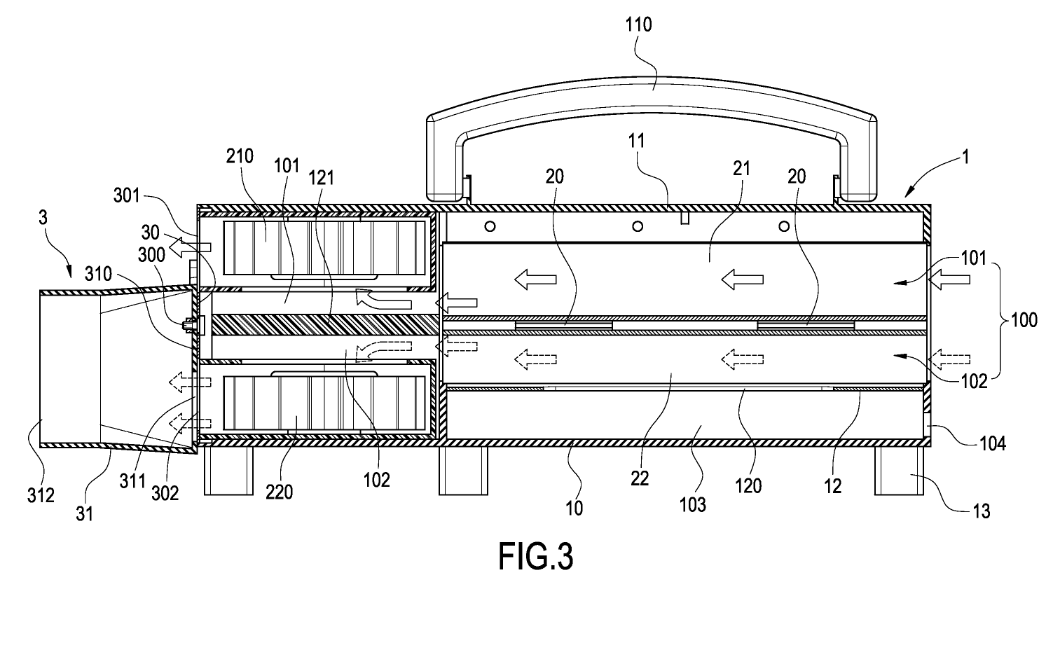

The cool/warm air conditioner 2 is transversely provided in the accommodating space 100 of the casing 1, so that the accommodating space 100 is divided into a first flowing path 101 and a second flowing path 102 (FIG. 3). Further, the first flowing path 101 and the second flowing path 102 are in communication with the inlet and the outlet of the accommodating space 100, so that the first flowing path 101 and the second flowing path 102 are substantially two flowing paths parallel to each other. The cool/warm air conditioner 2 can be constituted of at least one thermoelectric cooling chip 20, a first heat-conducting body 21 and a second heat-conducting body 22 respectively adhered onto the cool and warm surfaces of the thermoelectric cooling chip 20. The first and second heat-conducting bodies 21, 22 can be used as heat dissipators, such as a heat dissipator made of aluminum extrusion, and are disposed in the first and second flowing paths, respectively. In this way, the thermoelectric cooling chip 20 can generate heat conduction to respectively cool or warm up the temperature of the first and second heat-conducting bodies 21, 22. For example, the first heat-conducting body 21 is brought into contact with the hot surface of the thermoelectric cooling chip 20, while the second heat-conducting body 22 is brought into contact with the cold surface of the thermoelectric cooling chip 20. In this way, the cool or warm temperature generated by the thermoelectric cooling chip 20 can be transferred in a form of airflow into the first and second flowing paths 101, 102 via the first and second heat-conducting bodies 21, 22, respectively.

According to above, the cool/warm air conditioner 2 is further provided at the first and second flowing paths 101, 102 of the accommodating space 100 with a first wind unit 210 and a second wind unit 220. The first and second wind units 210, 220 are located in the vicinity of outlet of the accommodating space 100 and each can be a fan for heat dissipation, such as a centrifugal fan, thereby to facilitate the generation of airflow within the first and second flowing paths 101, 102. Therefore, the air outside the casing 1 can enter via the inlet of the accommodating space 100 (FIG. 3), and pass through the first and second flowing paths 101, 102, respectively. Thereby, the cool and warm temperature distributed therein can generate a cool and a warm airflow respectively and then delivered to the outlet of the accommodating space 100. Further, a partition 121 can be provided between the first and second wind units 210, 220. The partition 121 serves as a continuation of the cool/warm air conditioner 2 and partitions the first and second flowing paths 101, 102 adjacent to the outlet of the accommodating space 100.

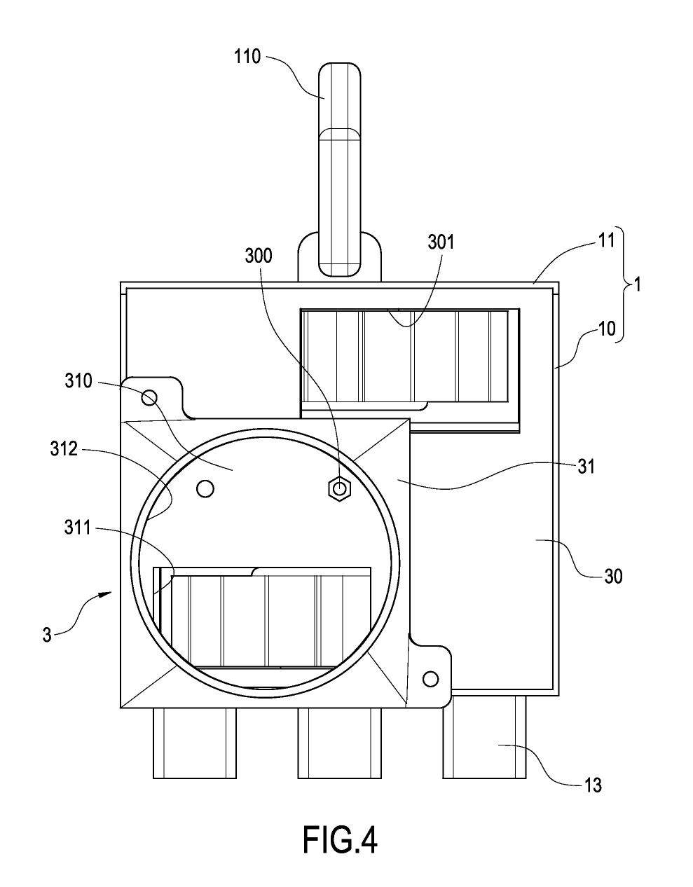

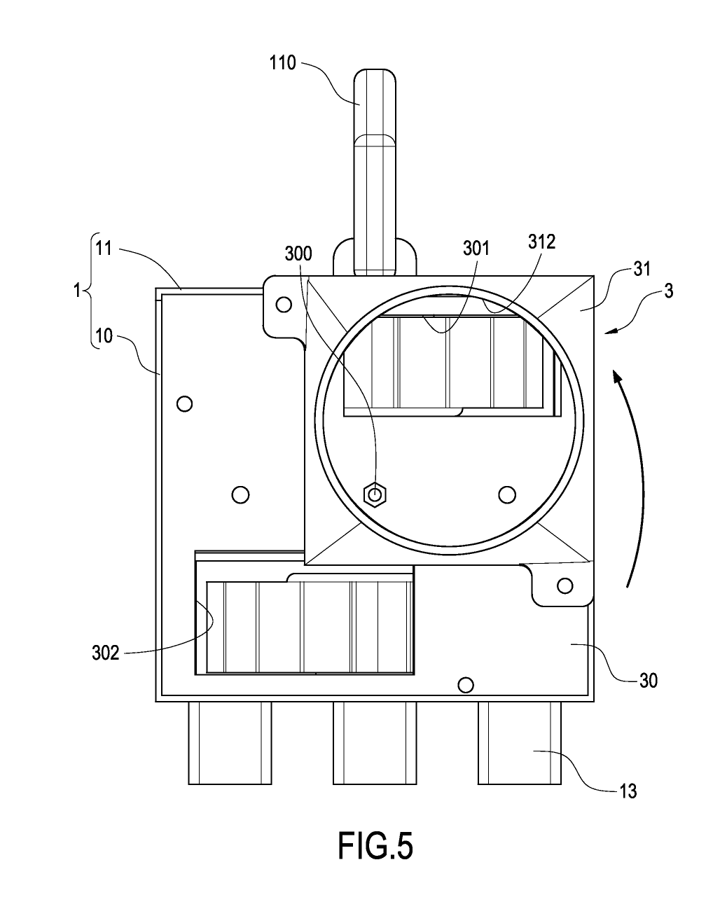

The airflow-dividing valve 3 is provided at the outlet of the accommodating space 100 of the casing 1 for delivering the cool airflow or warm airflow into the pet house 4 after being connected to an airflow conduit 400 (FIG. 6). In the present embodiment, the airflow-dividing valve 3 comprises a dividing plate 30 and a connecting pipe 31 pivotably provided onto the dividing plate 30. The dividing plate 30 is provided with a first air-supplying hole 301 and a second air-supplying hole 302 to correspond to the first and second flowing paths 101, 102 of the accommodating space 100, respectively. A central pivot 300 is positioned between the first and second air-supplying holes 301, 302. Further, one end of the connecting pipe 31 is provided with a blocking plate 310, and the other end thereof is open and provided with a connecting port 312. The blocking plate 310 is pivotably connected to the pivot 300 of the dividing plate 30. The blocking plate 310 is provided with a ventilating hole 311. When the connecting pipe 31 is pivotably connected to the dividing plate 30, the ventilating hole 311 will at least overlap with one of the first and second air-supplying holes 301, 302 (FIG. 4). Further, after turning the connecting pipe 31, the ventilating hole 311 will overlap with the other one of the first and second air-supplying holes 301, 302 (FIG. 5).

With reference to FIGS. 3 and 6, since the cool/warm air conditioner 2 can produce a cool and a warm temperature at the same time, and the cool and warm temperatures are transferred in a form of airflow into the first and second flowing paths 101, 102 via the first and second heat-conducting bodies 21, 22, respectively. Then, the first and second wind units 210, 220 deliver the cool and warm airflow generated in the first and second flowing paths 101, 102 to the first and second air-supplying holes 301, 302 of the airflow-dividing valve 3. The connecting port 312 of the airflow-dividing valve 3 is used to connect to one end of the airflow conduit 400 of the pet house 4, and the other end thereof is connected to the intake 40 of the pet house 4. With the above arrangement, the cool or warm airflow in one of the first and second flowing paths 101, 102 can be delivered into the pet house 4, thereby to achieve the effect of air conditioning. The cool or warm airflow in the other one of the first and second flowing paths is exhausted to the outside.

With reference to FIGS. 4 and 5, if the user intends to switch the cool airflow into the warm airflow or switch the warm airflow into the cool airflow, it is only necessary to turn the connecting pipe 31 of the airflow-dividing valve 3 to another valve position so as to easily achieve the switching operation of the cool/warm airflow. Therefore, an air-conditioning device capable of generating cool/warm airflow can be obtained.

Further, with reference to FIG. 3, in the present invention, a water-collecting trough 103 is further formed under the accommodating space 100 of the casing 1, which is formed by a water-dividing plate 12 transversely provided adjacent to the underside of the accommodating space 100. Draining holes 120 are provided on the water-dividing plate 12, so that the condensed droplets generated from the cool airflow in the second flowing path 102 can flow into the water-collecting trough 103 via the draining holes 120 on the water-dividing plate 12. Further, the underside of the base 10 is provided with a draining port 104 in communication with the water-collecting trough 103, thereby to facilitate the drainage of the collected water.

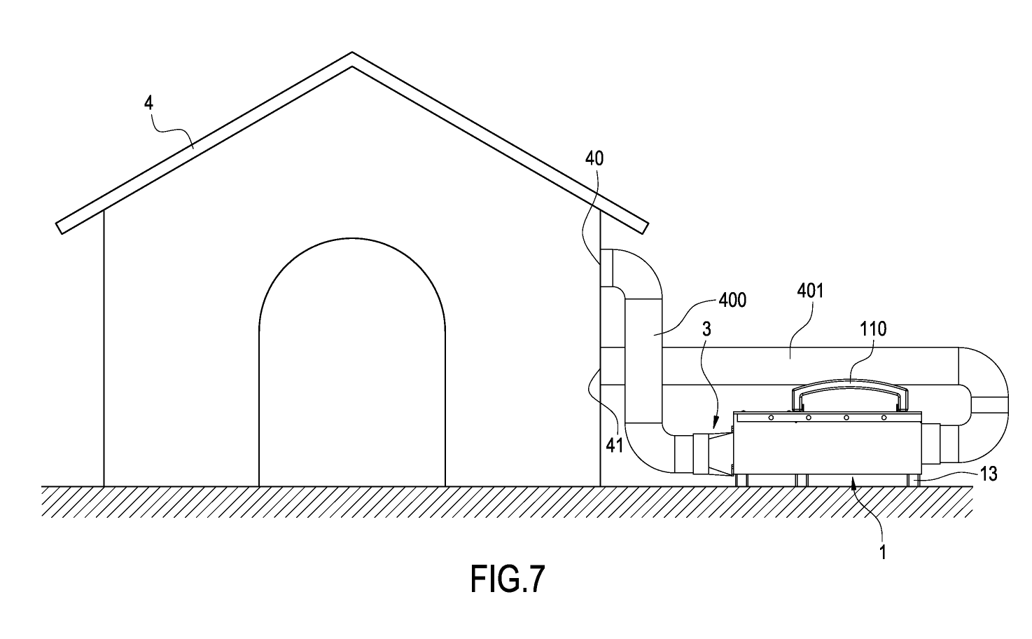

Further, as shown in FIG. 7, in order to efficiently utilize the circulation of airflow, the pet house 4 is provided with a ventilating port 41 connected to the inlet of the accommodating space 100 via another airflow conduit 401. Therefore, the cool or warm airflow delivered by the air-conditioning device can be delivered into the casing 1 again to directly use a cooler or warmer airflow to perform heat exchange, thereby to increase the heat-exchange efficiency.

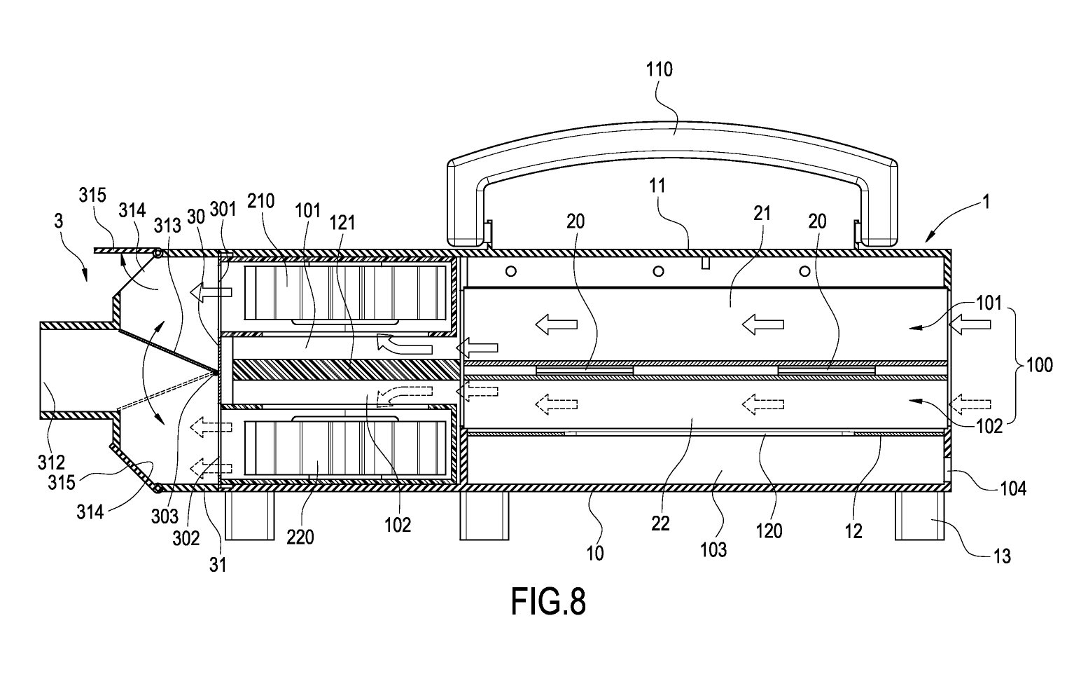

Further, as shown in FIG. 8, it is a cross-sectional view of the second embodiment of the air-conditioning device of the present invention. The dividing plate 30 of the airflow-dividing valve 3 is provided with a pivoting portion 303 thereon for pivotably connecting onto one end of a valve position plate 313 that is able to swing on the dividing plate 30. The valve position plate 313 is located within the connecting pipe 31, and the other end thereof abuts against the inner wall of the connecting port 312, thereby to divide the interior of the connecting pipe 31 into two spaces. The connecting pipe 31 corresponds to the outlet of the accommodating space 100 for covering the outlet of the accommodating space 100 and communicating therewith. In this way, the airflow exhausted from the first and second air-supplying holes 301, 302 can be delivered into the two spaces of the connecting pipes 12, respectively. Further, the connecting port 312 of the connecting pipe 31 is provided with an exhausting port 314 to correspond to the first and second air-supplying holes 301, 302, respectively. Each exhausting port 314 is pivotably provided with a cover 315 for covering thereon. Therefore, the valve position plate 313 can adjust the valve position thereof to open the corresponding exhausting port 314 and close another exhausting port 314, so that the desired airflow can be exhausted via the connecting port 312.

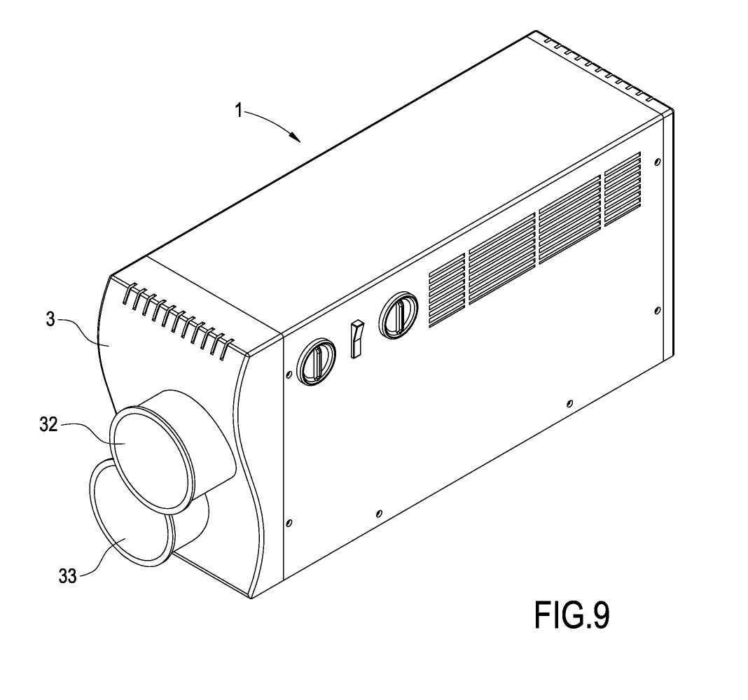

Further, as shown in FIG. 9, it is a cross-sectional view of the third embodiment of air-conditioning device of the present invention. The airflow-dividing valve 3 also comprises two connecting pipes 32, 33. The two connecting pipes 32, 33 correspond to the first and second air-supplying holes 301, 302, respectively, so that one of the two connecting pipes 32, 33 can be selected to be connected to the pet house 4 for supplying the cool or warm airflow to the pet house 4. The airflow provided by the other connecting pipe is exhausted to the outside air directly, and vice versa.

Therefore, with the above structure, the air-conditioning device for pets of the present invention and the pet house having such air-conditioning device can be obtained.

According to the above, the present invention indeed achieves the desired effects and solves the drawbacks of prior art. Further, the present invention involves the novelty and inventive steps and conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. An air-conditioning device for pets, capable of adjusting the temperature of air within a pet house, comprising:
a casing having an accommodating space therein, the accommodating space being open and having an inlet and an outlet;
a cool/warm air conditioner provided in the accommodating space and dividing the accommodating space into a first flowing path and a second flowing path, thereby to provide the first and second flowing paths with a cool temperature and a warm temperature; and
an airflow-dividing valve comprising a dividing plate provided at the outlet of the accommodating space and a connecting pipe provided on the dividing plate, the dividing plate provided with a first and a second air-supplying holes to correspond to the first and second flowing paths;
wherein the first and second flowing paths are provided with a first wind unit and a second wind unit therein, respectively, with the airflow generated by the first and second wind units, the cool/warm temperature air generated by the cool/warm air conditioner is transferred in a form of airflow to the first and second air-supplying holes, and the cool/arm airflow is able to be selected via the connecting pipe to inject into the pet house.

2. The air-conditioning device for pets according to claim 1, wherein the casing comprises a base and an upper cover for covering the top of the base, and the accommodating space is formed within the base.

3. The air-conditioning device for pets according to claim 1, wherein a handle is provided above the casing.

4. The air-conditioning device for pets according to claim 1, wherein a plurality of supporting legs is provided under the casing.

5. The air-conditioning device for pets according to claim 1, wherein a water-collecting trough is provided under the accommodating space of the casing, and a draining port is provided under the casing in communication with the water-collecting trough.

6. The air-conditioning device for pets according to claim 5, wherein a water-dividing plate is transversely provided above the water-collecting trough, and draining holes are provided on the water-dividing plate.

7. The air-conditioning device for pets according to claim 1, wherein the cool/warm air conditioner comprises a thermoelectric cooling chip and a first and a second heat-conducting bodies for adhering onto the cold and hot surface of the thermoelectric cooling chip, respectively, and the first and second heat-conducting bodies are arranged in the first and second flowing paths, respectively.

8. The air-conditioning device for pets according to claim 7, wherein the first and second heat-conducting bodies are heat dissipators.

9. The air-conditioning device for pets according to claim 1, wherein the dividing plate of the airflow-dividing valve is pivotably connected to an end opening of the connecting pipe, so that the connecting pipe is capable of turning on the dividing plate, the turning of the connecting pipe makes the end opening to be brought in communication with the first or second air-supplying hole.

10. The air-conditioning device for pets according to claim 9, wherein a central pivot is provided on the dividing plate, an end opening of the connecting pipe is provided with a blocking plate pivotably connected to the pivot, and the blocking plate is provided with a ventilating hole in communication with the first or second air-supplying hole.

11. The air-conditioning device for pets according to claim 1, wherein a pivoting portion is provided on the dividing plate of the airflow-dividing valve for pivotably connecting to one end of the valve position plate, the valve position plate is located in the connecting pipe and is able to swing on the dividing plate to allow the other end thereof to abut against the inner wall of the connecting pipe, thereby to divide the connecting pipe into two spaces; and the connecting pipe corresponds to the outlet of the accommodating space, the end of the connecting port of the connecting pipe is each provided with an exhausting port to correspond to the first and second air-supplying holes, respectively, and each exhausting port is provided with a cover for covering thereon.

12. The air-conditioning device for pets according to claim 1, wherein the airflow-dividing valve comprises two connecting pipes, and the two connecting pipes correspond to the first and second air-supplying holes.

13. The air-conditioning device for pets according to claim 1, wherein the first and second wind units are fans.

14. A pet house having an air-conditioning device, comprising:
a pet house having an intake and an exhausting port;
a casing having an accommodating space therein, the accommodating space being open and having an inlet and an outlet;
a cool/warm air conditioner provided in the accommodating space and dividing the accommodating space into a first flowing path and a second flowing path, thereby to provide the first and second flowing paths with a cool temperature and a warm temperature, and the first and second flowing paths provided with a first wind unit and a second wind unit therein, respectively; and
an airflow-dividing valve comprising a dividing plate provided at the outlet of the accommodating space and a connecting pipe provided on the dividing plate, and the dividing plate provided with a first and a second air-supplying holes to correspond to the first and second flowing paths, respectively;
wherein an airflow conduit is connected between the intake of the pet house and the connecting pipe, another airflow conduit is connected between the exhausting port of the pet house and the inlet of the accommodating space, thereby to increase the heat-exchange efficiency of the cool/warm air conditioner by means of the circulation of airflow.
